(19) United States
(12) Patent Application Publication
(10) Pub. No.: US 2012/0091812 A1
(43) Pub. Date: Apr. 19, 2012

(54) POWER SWITCHING DEVICE

(75) Inventors: Yu-Ching Lin, Taichung City (TW); Chih-Chung Tsai, Hsinchu County (TW)

(73) Assignee: UPI SEMICONDUCTOR CORP., Hsinchu County (TW)

(21) Appl. No.: 13/004,037

(22) Filed: Jan. 11, 2011

(30) Foreign Application Priority Data
Oct. 15, 2010 (TW) 99135255

(51) Int. Cl. H02J 9/06

(52) U.S. Cl. 307/66

(57) ABSTRACT

A power switching device including a rectifier circuit and a control circuit is provided. A first terminal of the rectifier circuit receives an external voltage source and a second terminal of the rectifier circuit is electrically connected to a node. The control circuit is electrically connected between the node and a battery. Furthermore, during a power supply mode, the control circuit provides a power supply path, so that the battery provides a battery current to the node. Besides, the control circuit detects the battery current and determines whether or not to switch to a normal mode from the power supply mode according to the detection result.

### CROSS-REFERENCE TO RELATED APPLICATION

This application claims the priority benefit of Taiwan application serial no. 99135255, filed on Oct. 15, 2010. The entirety of the above-mentioned patent application is hereby incorporated by reference herein and made a part of this specification.

### BACKGROUND

1. Field of the Invention

The invention relates to a power switching device. Particularly, the invention relates to a power switching device capable of determining a power supply mechanism according to a current and voltage detection technique.

2. Description of Related Art

Generally, a portable electronic device can be connected to an external voltage source by connecting an adapter or a universal serial bus (USB) receptacle. Moreover, in order to implement portability of the portable electronic device, a system voltage can also be supplied by a battery inside the portable electronic device. In other words, there are two types of power supplies of the portable electronic device, one is the external voltage source, and another one is supplied by battery.

In order to suitably switch sources of the system voltage, the portable electronic device generally switches the power supplies through a power switching device. In this way, besides using the battery to supply power, when being connected to the external voltage source, the portable electronic device can also use the external voltage source and/or the battery to supply power. Moreover, based on the switching operation of the power switching device, the potable electronic device can also use the external voltage source to charge the internal battery.

Overall, the power switching device controls a priority of the system power supply, so as to control a current flow between various power supplies. Therefore, the power switching device is an indispensable device in utilization of the portable electronic device.

### SUMMARY OF THE INVENTION

The invention is directed to a power switching device, which can use a voltage detection mechanism and a current detection mechanism to control a priority of power supply, so as to improve stableness of the system.

The invention provides a power switching device including a rectifier circuit and a control circuit. A first terminal of the rectifier circuit receives an external voltage source and a second terminal of the rectifier circuit is electrically connected to a node. The control circuit is electrically connected between the node and a battery. Furthermore, under a power supply mode, the control circuit provides a power supply path, so that the battery provides a battery current to the node, and the control circuit detects the battery current and determines whether or not to switch to a charging mode from the power supply mode according to a detection result.

In an embodiment of the invention, the control circuit compares a system voltage with a battery voltage of the battery, so as to determine whether or not to enter the power supply mode.

In an embodiment of the invention, under the charging mode, the control circuit provides a predetermined charging current according to the battery voltage and supplies the system voltage.

In an embodiment of the invention, the control circuit includes a switching unit and a detection unit. The switching unit is electrically connected between the node and the battery. Moreover, the switching unit turns on the power supply path under the power supply mode, and generates a predetermined charging current with reference of the battery voltage under the charging mode. On the other hand, the detection unit is connected to the switching unit in parallel. Moreover, the detection unit stops operation under the charging mode, and extracts a portion of the battery current under the power supply mode to determine whether or not to generate a control signal, wherein the switching unit turns off the power supply path according to the control signal.

According to the above descriptions, the control circuit of the invention has the power detection mechanism and the current detection mechanism. Therefore, the control circuit can control the priority of the power supply according to a load proportion. In this way, the power switching device can manage a current flow between various power supplies according to the load proportion, so as to improve stableness of the system.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block schematic diagram illustrating a power switching device 100 according to an embodiment of the invention.

FIG. 2 is a block schematic diagram illustrating a power switching device 100 according to another embodiment of the invention.

### DETAILED DESCRIPTION OF DISCLOSED EMBODIMENTS

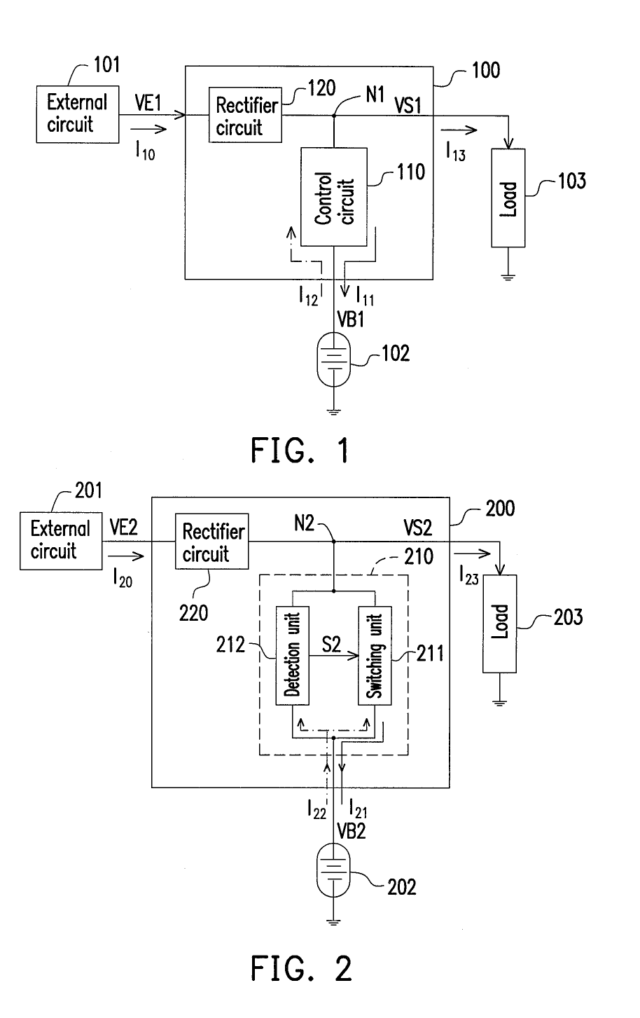

FIG. 1 is a block schematic diagram illustrating a power switching device 100 according to an embodiment of the invention. The power switching device 100 receives an external voltage source VE1 from an external circuit 101 through a rectifier circuit 120. For supplying power to a post-end load 103, a system voltage VS1 is powered from the external voltage source VE1 or the battery voltage VB 1 provided by a battery 102. In an actual application, the power switching device 100 can be applied in a portable electronic device. Now, the load 103 is equivalent to an internal circuit of the portable electronic device, and the external circuit 101 is, for example, an adapter or a universal serial bus (USB) receptacle.

Referring to FIG. 1, the power switching device 100 includes the rectifier circuit 120 and a control circuit 110. A first terminal of the rectifier circuit 120 receives the external voltage source VE1 and a second terminal of the rectifier circuit 120 is electrically connected to a node N1. The rectifier circuit 120 rectifies the external voltage source VE1. Moreover, the control circuit 110 is electrically connected between the node N1 and the battery 102.

On the other hand, the control circuit 110 has two modes of a charging mode and a power supply mode. The control circuit 110 detects the system voltage VS1 on the node N1, i.e. the voltage supplied to the load 103, and compares the system voltage VS1 with the battery voltage VB1. In this way, when the system voltage VS1 is smaller than the battery voltage VB1, the control circuit 110 enters the power supply mode. Moreover, when a battery current I₁₂ is smaller than a predetermined value, the control circuit 110 enters the charging module from the power supply mode.

Under the charging mode, the control circuit 110 provides a predetermined charging current I₁₁ to charge the battery 102. Now, if an external supply current provided to the power switching device 100 by the external circuit 101 is referred as I₁₀, and a power supply current provided to the load 103 by the power switching device 100 is referred as I₁₃, a relationship of the external supply current I₁₀, the predetermined charging current I₁₁ and the power supply current I₁₃ is as that shown by a following equation (1):

I₁₀−I₁₁=I₁₃ equation (1)

Under the power supply mode, the control circuit 110 turns on a power supply path, so that the battery 102 provides the battery current I₁₂ to the node N1. In this way, the battery 102 can supply a current to the load 103. Now, a relationship of the external supply current I₁₀, the battery current I₁₂ and the power supply current I₁₃ is as that shown by a following equation (2):

I₁₀+I₁₂=I₁₃ equation (2)

Moreover, during a power supplying process of the battery 102, the control circuit 110 detects a magnitude of the battery current I₁₂, and determines whether or not to switch the power supply mode to the charging mode according to the detection result. For example, when the power supply current I₁₃ is gradually decreased, i.e. when the battery current I₁₂ is gradually decreased and is smaller than the predetermined value, the control circuit 110 turns off the power supply path, so that the control circuit 110 returns back to the charging mode.

In other words, the control circuit 110 of the present embodiment uses a voltage detection mechanism and a current detection mechanism to control a priority of power supply. In this way, the power switching device 100 can manage a current flow between various power supplies according to a load proportion, so as to improve stableness of the system. In order to fully convey the spirit of the invention to those skilled in the art, another power switching device is provided below for reference.

FIG. 2 is a block schematic diagram illustrating a power switching device 200 according to another embodiment of the invention. The power switching device 200 receives an external voltage source VE2 from an external circuit 201 through a rectifier circuit 220. For supplying power to a post-end load 203, a system voltage VS2 is powered from the external voltage source VE2 or the battery voltage VB2 provided by a battery 202. Moreover, as shown in FIG. 2, the power switching device 200 includes the rectifier circuit 220 and a control circuit 210, and the control circuit 210 includes a switching unit 211 and a detection unit 212.

Referring to FIG. 2, a first terminal of the rectifier circuit 220 receives the external voltage source VE2 and a second terminal of the rectifier circuit 220 is electrically connected to a node N2. The rectifier circuit 220 rectifies the external voltage source VE2. Moreover, the switching unit 211 and the detection unit 212 in the control circuit 210 are connected in parallel between the node N2 and the battery 202.

In view of operation, the control circuit 210 has two modes of a charging mode and a power supply mode. The control circuit 210 detects the system voltage VS2 on the node N2, and compares the system voltage VS2 with the battery voltage VB2. In this way, when the system voltage VS2 is smaller than the battery voltage VB2, the control circuit 210 enters the power supply mode. Moreover, when a battery current I₂₂ is smaller than a predetermined value, the control circuit 210 enters the charging module from the power supply mode.

Under the charging mode, the detection unit 212 stops operating. Moreover, the switching unit 211 generates a predetermined charging current I₂₁ to charge the battery 202. Now, if an external supply current provided to the power switching device 200 by the external circuit 201 is referred as I₂₀, and a power supply current provided to the load 203 by the power switching device 200 is referred as I₂₃, a relationship of the external supply current I₂₀, the predetermined charging current I₂₁ and the power supply current I₂₃ is as that shown by a following equation (3):

I₂₀−I₂₁=I₂₃ equation (3)

Under the power supply mode, the switching unit 211 turns on a power supply path, and the detection unit 212 starts to operate. In this way, the battery current I₂₂ provided by the battery 202 flows through the switching unit 211 and the detection unit 212, respectively. Comparatively, the battery current I₂₂ provided by the battery 202 is transmitted to the node N2 through the power supply path of the switching unit 211, so as to supply power to the post-end load 203. Now, a relationship of the external supply current I₂₀, the battery current I₂₂ and the power supply current I₂₃ is as that shown by a following equation (4):

I₂₀+I₂₂=I₂₃ equation (4)

Moreover, the detection unit 212 extracts a portion of the battery current I₂₂ to determine whether or not to generate a control signal S2. For example, when the portion of the battery current I₂₂ extracted by the detection unit 212 is smaller than a threshold current, the detection unit 212 generates the control signal S2. Moreover, the control signal S2 is transmitted to the switching unit 211, and the switching unit 211 accordingly turns off the power supply path.

In summary, the control circuit of the invention uses the power detection mechanism and the current detection mechanism to control the priority of power supply. In this way, the power switching device can manage a current flow between various power supplies according to the load proportion, so as to improve stableness of the system.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A power switching device, comprising:
a rectifier circuit, having a first terminal receiving an external voltage source and a second terminal electrically connected to a node; and
a control circuit, electrically connected between the node and a battery, wherein under a power supply mode, the control circuit provides a power supply path, so that the battery provides a battery current to the node, and the control circuit detects the battery current and determines whether or not to switch to a charging mode from the power supply mode according to a detection result.

2. The power switching device as claimed in claim 1, wherein the control circuit detects a system voltage dropped on the node and compares the system voltage with a battery voltage of the battery, so as to determine whether or not to enter the power supply mode.

3. The power switching device as claimed in claim 2, wherein when the system voltage is smaller than the battery voltage, the control circuit enters the power supply mode.

4. The power switching device as claimed in claim 2, wherein under the charging mode, the control circuit provides a predetermined charging current to charge the battery.

5. The power switching device as claimed in claim 2, wherein the control circuit comprises:
a switching unit, electrically connected between the node and the battery, wherein the switching unit turns on the power supply path under the power supply mode, and generates a predetermined charging current under the charging mode; and
a detection unit, connected to the switching unit in parallel, wherein the detection unit stops operating under the charging mode, and extracts a portion of the battery current under the power supply mode to determine whether or not to generate a control signal, wherein the switching unit turns off the power supply path according to the control signal.

6. The power switching device as claimed in claim 5, wherein when the portion of the battery current extracted by the detection unit is smaller than a threshold current, the detection unit generates the control signal.
